(19) United States
(12) Patent Application Publication
(10) Pub. No.: US 2018/0039343 A1
(43) Pub. Date: Feb. 8, 2018

(54) STYLUS PEN HOUSING WITH MOVABLE CONNECTOR DEVICE

(71) Applicant: HEWLETT-PACKARD DEVELOPMENT COMPANY, L.P., HOUSTON, TX (US)

(72) Inventor: CHAN PARK, HOUSTON, TX (US)

(21) Appl. No.: 15/542,879

(22) PCT Filed: Apr. 28, 2015
(86) PCT No.: PCT/US2015/028040

§ 371 Date: Jul. 11, 2017

(51) Int. Cl. G06F 3/0354; G06F 1/16

(52) U.S. Cl. CPC G06F 3/03545; G06F 1/1632; G06F 2200/1632

(57) ABSTRACT

Example implementations relate to a pen housing with a movable connector device. For example, a housing may include at least one wall capable of surrounding a stylus pen and a movable connector device affixed to an inner portion of the at least one wall. The movable connector device may include a connector component protruding into the housing and capable of connecting to a contact area of the stylus pen. The movable connector device may also include a moving mechanism capable of moving the movable connector device toward the stylus pen in the housing only when the contact area of the stylus pen is aligned with the movable connector device.

### BACKGROUND

Computing devices may be operated using various accessories, such as a keyboard, a mouse, and the like. A stylus pen is another such accessory that may be used as an input device for a computing device. For example, a stylus pen may be used on a touch screen computing device to provide an input to the touch screen computing device.

### BRIEF DESCRIPTION OF THE DRAWINGS

Some examples of the present application are described with respect to the following figures:

FIG. 1 is a block diagram of an example system with a stylus pen partially housed in a housing having a magnetic movable connector device to connect the stylus pen to the housing;

FIG. 2 is a block diagram of an example system with a stylus pen fully housed in a housing having a magnetic movable connector device to connect the stylus pen to the housing;

FIG. 3 is a block diagram of an example system with a stylus pen partially housed in a housing having a mechanical movable connector device to connect the stylus pen to the housing;

FIG. 4 is a block diagram of an example system with a stylus pen also partially housed in a housing having a mechanical movable connector device to connect the stylus pen to the housing;

FIG. 5 is a block diagram of an example system with a stylus pen also partially housed in a housing having a mechanical movable connector device to connect the stylus pen to the housing; and

FIG. 6 is a block diagram of an example system with a stylus pen fully housed in a housing having a mechanical movable connector device to connect the stylus pen to the housing.

### DETAILED DESCRIPTION

As described above, a stylus pen may be used as an input device to a computing device. A stylus pen may be a pen-shaped instrument that may be used to input commands to a touch screen computing device by placing the stylus pen on the surface of the touch screen to provide the input command. In some examples, a stylus pen may also be a computing device capable of performing various functions. As such, in some examples, a stylus pen may operate using any suitable power source (e.g., an internal battery), where the power source may be powered in any suitable manner (e.g., by charging the internal battery using a charging station plugged into a power source). In some examples, a stylus pen may be housed in a housing providing power to the power source of the stylus pen. However, often times the housing's connector component used to connect the housing to the stylus pen may scratch or scrape the stylus pen while a user attempts to dock the stylus pen in the housing, damaging the exterior of the stylus pen.

To prevent damage to the exterior of the stylus pen, a stylus pen housing may have a connector device that may be used to connect the housing to the stylus pen, where the connector device is movable such that the connector component of the connector device does not make contact with the stylus pen until a contact area of the stylus pen is aligned with the connector device. The contact area of the stylus pen may be a portion of the stylus pen to which the connector component of the housing connects.

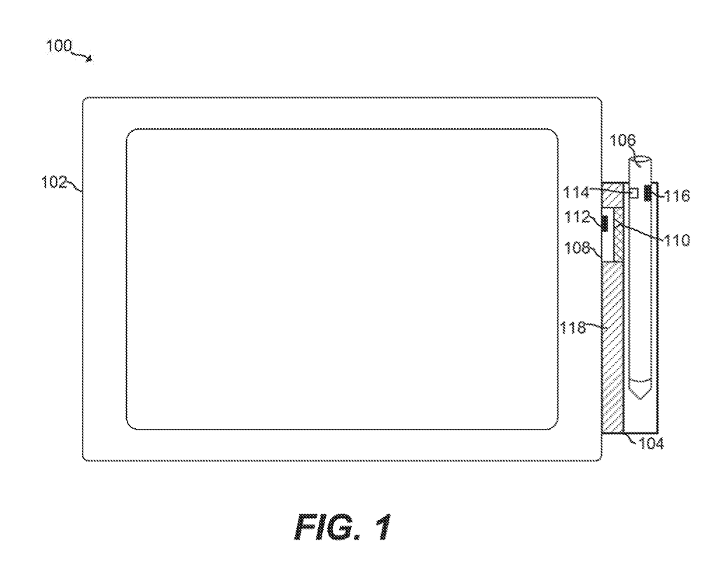

Referring now to the figures, FIG. 1 is a block diagram of an example system 100 with a stylus pen 106 partially housed in a housing 104 having a magnetic movable connector device 108 to connect the stylus pen 106 to the housing 104. The system 100 may include a computing device 102, which may be any suitable computing device with which the stylus pen 106 may be used, such as a notebook computer, a desktop computer, an all-in-one system, a tablet computing device, a mobile phone, a touch screen device, an electronic book reader, a printing device, and the like. The computing device 102 may include at least one processor capable of performing various functions.

The stylus pen 106 may be any suitable stylus pen that may be used to provide input commands to the computing device 102. The stylus pen 106 may be housed in and/or removed from the housing 104, which may be any suitable housing capable of docking the stylus pen 106. In some examples, the stylus pen 106 may be charged when the stylus pen 106 is connected to the housing 104. For example, the housing 104 may provide power to the stylus pen 106 when the stylus pen 106 is fully housed in housing 104. In some examples, the housing 104 may provide power to the stylus pen 106 from the computing device 102.

The housing 104 may be connected to and in communication with the computing device 102. The housing 104 may be separate from, detachable from, and/or part of the computing device 102. The housing 104 may include at least one wall (e.g., wall 118) capable of surrounding the stylus pen 106. For example, the housing 104 may include a circular wall surrounding the stylus pen 106, multiple walls forming a shape that surrounds the stylus pen 106, and the like.

The housing 104 may also include a movable connector device 108 affixed to an inner portion of the at least one wall (e.g., wall 118) of the housing 104, where the inner portion of the at least one wall is a portion that faces toward the inside of the housing 104. The movable connector device 108 may be affixed to the inner portion of the at least one wall of the housing 104 in any suitable manner (e.g., affixed using a spring, a hinge, etc.) such that the movable connector device 108 is capable of moving with respect to the housing 104.

The movable connector device 108 may include a connector component 110, which may be any suitable component capable of protruding into the housing 104 such that it may connect with a contact area 114 of the stylus pen 106. The connector component 110 may facilitate a connection between the housing 104 and the stylus pen 106 when the connector component 110 is inserted into the contact area 114 of the stylus pen 106. The contact area 114 of the stylus pen 106 may be any suitable contact area capable of receiving and connecting with the connector component 110 of the movable connector device 108. The contact area 114 may be capable of receiving power from the housing 104 and/or the computing device 102 via the movable connector device 108 such that the stylus pen 106 may be charged.

The movable connector device 108 may also include a moving mechanism 112 in the form of at least one magnet. The moving mechanism 112 may be capable of moving the movable connector device 108 toward the stylus pen 106 when the contact area 114 of the stylus pen 106 is aligned with the connector component 110 of the movable connector device 108 such that the movable connector device 108 makes no contact with the stylus pen 106 until the contact area 114 of the stylus pen 106 is aligned with the connector component 110. In the example of FIG. 1, the moving mechanism 112 may move the movable connector device 108 toward the stylus pen 106 when the connector component 110 is aligned with the contact area 114 using the magnetic attraction of the moving mechanism 112 to the magnet 116 in the stylus pen 106.

The system 100 of FIG. 1 shows the stylus pen 106 partially inserted in the housing 104. The connector component 110 of the movable connector device 108 is not aligned with the contact area 114 of the stylus pen 106, and as such, the movable connector device 108 has not yet been moved toward the stylus pen 106.

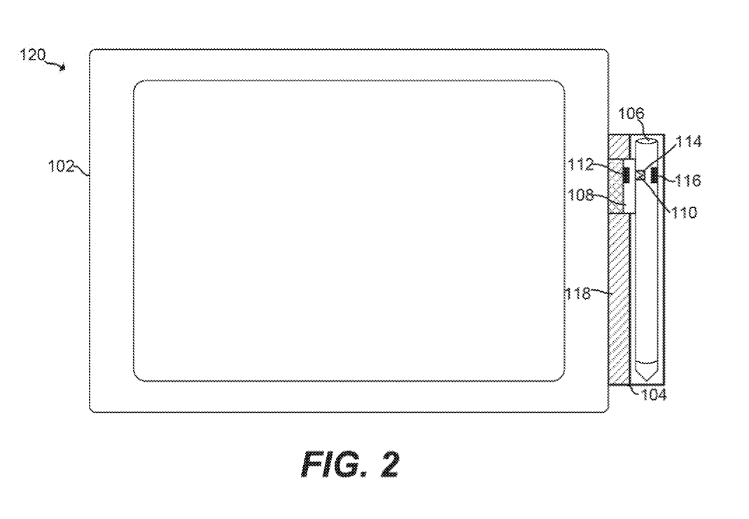

FIG. 2 is a block diagram of an example system 120 with the stylus pen 106 fully housed in the housing 104 having a magnetic movable connector device 108 to connect the stylus pen 106 to the housing 104. The example system 120 of FIG. 2 is similar to the example system 100 of FIG. 1, except that the stylus pen 106 in FIG. 2 is fully inserted and connected to the housing 104.

As shown in FIG. 2, when the connector component 110 of the movable connector device 108 is aligned with the contact area 114 of the stylus pen 106, the moving mechanism 112 becomes attracted to the magnet 116 such that the movable connector device 108 is moved toward the stylus pen, resulting in the connector component 110 being connected to the stylus pen 106 via the contact area 114 of the stylus pen 106, thereby preventing the connector component 110 from scraping or scratching the exterior of the stylus pen 106.

In some alternate examples, the movable connector device 108 with its connector component 110 and moving mechanism 112 may stay in place when the contact area 114 becomes aligned with the connector component 110, and instead, the contact area 114 may move toward the connector component 110 when the contact area 114 is aligned with the connector component 112 due to the magnetic attraction between the magnetic moving mechanism 112 and the magnet 116.

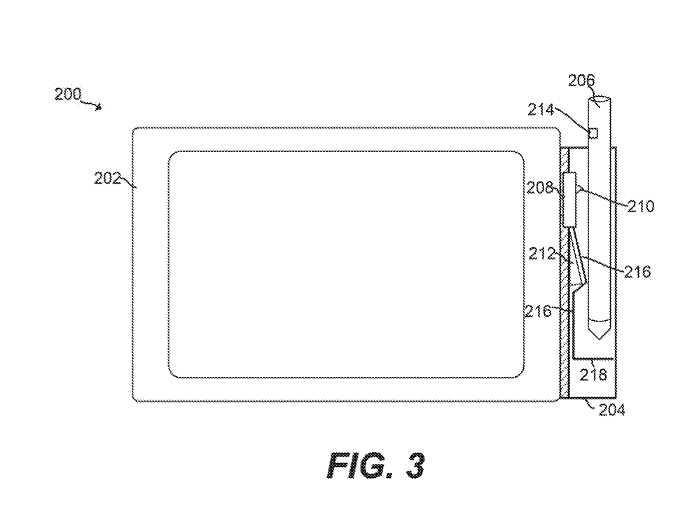

FIG. 3 is a block diagram of an example system 200 with a stylus pen 206 partially housed in a housing 204 having a mechanical movable connector device 208 to connect the stylus pen 206 to the housing 204. Similar to the example system 100 in FIG. 1 and the example system 120 in FIG. 2, the example system 200 of FIG. 3 may include a computing device 202 having at least one processor. The computing device 202 may be any suitable computing device with which the stylus pen 206 may be used to provide input commands to the computing device 202. The stylus pen 206 may be housed in and/or removed from the housing 204, which may be any suitable housing capable of docking the stylus pen 206 (e.g., a charging station).

The housing 204 may be connected to and in communication with the computing device 202. The housing 204 may be separate from, detachable from, and/or part of the computing device 202. The housing 204 may include at least one wall (e.g., wall 216, wall 218) capable of surrounding the stylus pen 206.

The housing 204 may also include a movable connector device 208 affixed to an inner portion of the at least one wall (e.g., wall 216) of the housing 204, where the inner portion of the at least one wall is a portion that faces toward the inside of the housing 204. The movable connector device 208 may be affixed to the inner portion of the at least one wall of the housing 208 in any suitable manner (e.g., affixed using a spring, a hinge, etc.) such that the movable connector device 208 is capable of moving with respect to the housing 204.

The movable connector device 208 may include a connector component 210, which may be any suitable component capable of protruding into the housing 204 such that it may connect with a contact area 214 of the stylus pen 206. The connector component 210 may facilitate a connection between the housing 204 and the stylus pen 206 when the connector component 210 is inserted into the contact area 214 of the stylus pen 206. The contact area 214 of the stylus pen 206 may be any suitable contact area capable of receiving and connecting with the connector component 210 of the movable connector device 208. The contact area 214 may be capable of receiving power from the housing 204 and/or the computing device 202 via the movable connector device 208 such that the stylus pen 206 may be charged.

The movable connector device 208 may also include a mechanical moving mechanism 212. The moving mechanism 212 may be capable of moving the movable connector device 208 toward the stylus pen 206 when the contact area 214 of the stylus pen 206 begins to align with the connector component 210 of the movable connector device 208 such that the movable connector device 208 makes no contact with the stylus pen 206 until the contact area 214 of the stylus pen 206 is aligned with the connector component 210. In the example of FIG. 3, the moving mechanism 212 may move the movable connector device 208 toward the stylus pen 206 as the connector component 210 begins to align with the contact area 214 by pushing the wall 216 toward the stylus pen 206 as the stylus pen 206 is inserted in the housing 204 and pushes the wall 218 of the housing 204 downward.

The system 200 of FIG. 3 shows the stylus pen 206 partially inserted in the housing 204. The connector component 210 of the movable connector device 208 is not aligned with the contact area 214 of the stylus pen 206, and as such, the movable connector device 208 has not yet made contact with the stylus pen 206.

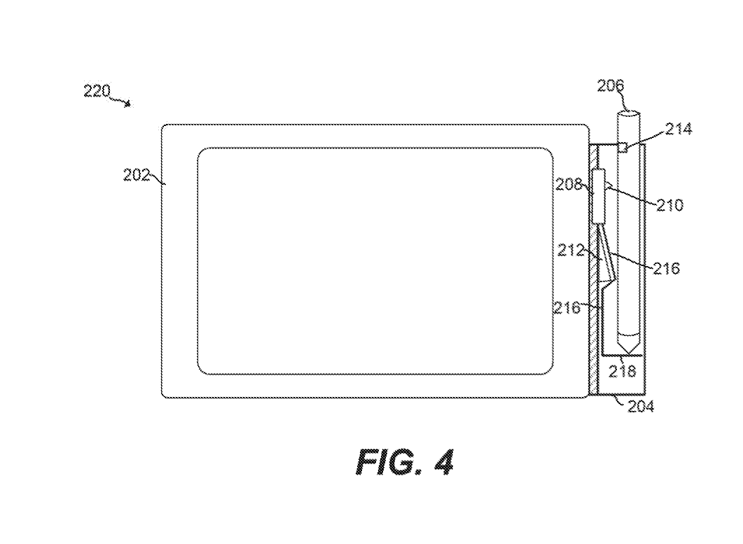

FIG. 4 is a block diagram of an example system 220 with the stylus pen 206 also partially housed in the housing 204 having a mechanical movable connector device 208 to connect the stylus pen 206 to the housing 204. The example system 220 of FIG. 4 is similar to the example system 200 of FIG. 3, except that the stylus pen 206 in FIG. 4 is further inserted into the housing 204.

As shown in FIG. 4, when the stylus pen 206 pushes the wall 218 downward, the wall 216 connected to the wall 218 and the movable connector device 208 connected to the wall 216 may be moved downward as well, causing the wall 216 and the movable connector device 208 to be pushed toward the stylus pen 206 by the moving mechanism 212. As the wall 218, wall 216, and movable connector device 208 are pushed downward by the downward force of the stylus pen 206 on the wall 218, portions of the wall 216 and the movable connector device 208 may be pushed toward the stylus pen 206 by the moving mechanism 212 as those portions move downward along the moving mechanism 212.

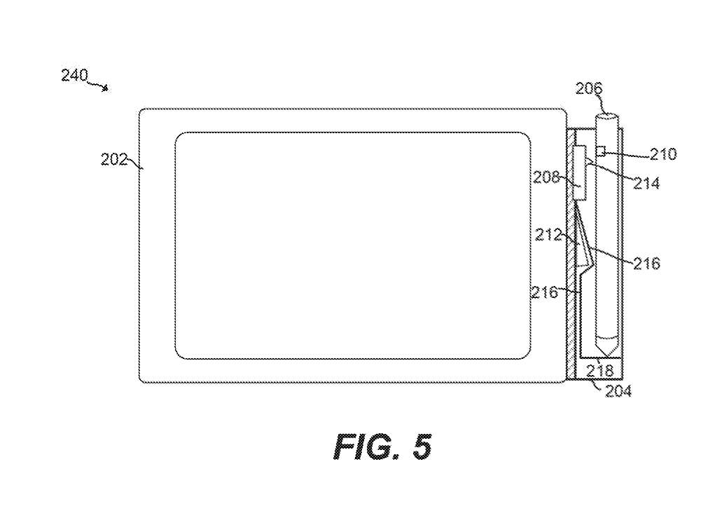

FIG. 5 is a block diagram of an example system 240 with the stylus pen 206 also partially housed in the housing 204 having a mechanical movable connector device 208 to connect the stylus pen 206 to the housing 204. The example system 240 of FIG. 5 is similar to the example system 200 of FIG. 3 and the example system 220 of FIG. 4, except that the stylus pen 206 in FIG. 5 is further inserted into the housing 204.

As shown in FIG. 5, when the stylus pen 206 pushes the wall 218 downward, the wall 216 connected to the wall 218 and the movable connector device 208 connected to the wall 216 may be moved downward as well, causing the wall 216 and the movable connector device 208 to be pushed toward the stylus pen 206 by the moving mechanism 212. As the wall 218, wall 216, and movable connector device 208 are pushed downward by the downward force of the stylus pen 206 on the wall 218, portions of the wall 216 and the movable connector device 208 may be pushed toward the stylus pen 206 by the moving mechanism 212 as those portions move downward along the moving mechanism 212. The example system 240 of FIG. 5 shows the movable connector device 208 being pushed further inward due to the stylus pen 206 being further inserted, as compared to the system 220 of FIG. 4.

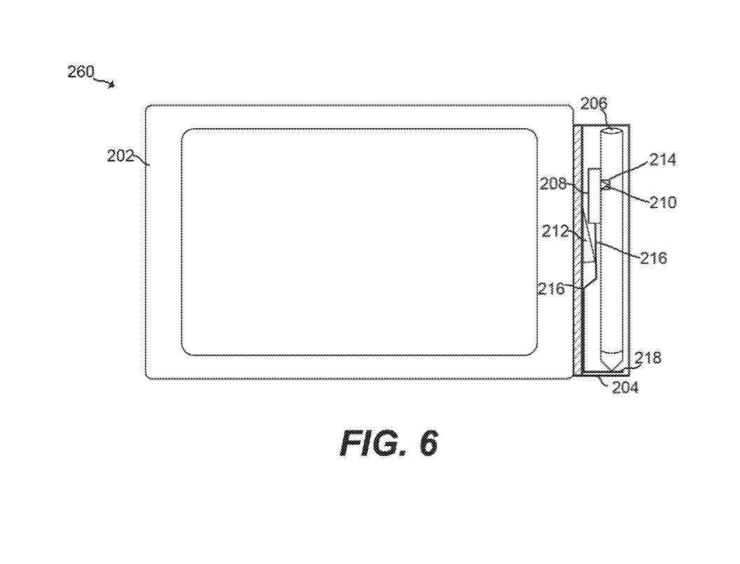

FIG. 6 is a block diagram of an example system 260 with the stylus pen 206 fully housed in the housing 204 having a mechanical movable connector device 208 to connect the stylus pen 206 to the housing 204. The example system 260 of FIG. 6 is similar to the example system 200 of FIG. 3, the example system 220 of FIG. 4, and the example system 240 of FIG. 5, except that the stylus pen 206 in FIG. 6 is fully inserted into the housing 204.

As shown in FIG. 6, when the stylus pen 206 is fully inserted in the housing 204, the moving mechanism 212 moves the movable connector device 208 toward the stylus pen 206 such that the connector component 210 is connected to the stylus pen via the contact area 214 of the stylus pen 206 when the connector component 210 is aligned with the contact area 210. As the stylus pen 206 is fully inserted into the housing 204, the moving mechanism 212 pushes the movable connector device 208 toward the stylus pen 206 such the housing becomes connected to the stylus pen when the connector component 210 is aligned with the contact area 214, thereby preventing the connector component 210 from scraping or scratching the exterior of the stylus pen 206.

What is claimed is:

1. A housing, comprising:
at least one wall capable of surrounding a stylus pen; and
a movable connector device affixed to an inner portion of the at least one wall, the movable connector device comprising:
a connector component protruding into the housing and capable of connecting to a contact area of the stylus pen; and
a moving mechanism capable of moving the movable connector device toward the stylus pen in the housing only when the contact area of the stylus pen is aligned with the connector component.

2. The housing of claim 1, wherein the moving mechanism comprises at least one magnet capable of being attracted to a magnet in the stylus pen.

3. The housing of claim 1, wherein the moving mechanism is a mechanical mechanism capable of moving the movable connector device toward the stylus pen.

4. The housing of claim 1, wherein the housing is part of a computing device.

5. The housing of claim 1, wherein the movable connector device is capable of charging the stylus pen.

6. The housing of claim 1, wherein the movable connector device makes no contact with the stylus pen until the contact area of the stylus pen is aligned with the connector component.

7. A system, comprising:
a stylus pen; and
a housing comprising:
at least one wall capable of surrounding the stylus pen; and
a movable connector device affixed to an inner portion of the at least one wall, the movable connector device comprising:
a connector component protruding into the housing and capable of connecting to a contact area of the stylus pen; and
a moving mechanism capable of moving the movable connector device toward the stylus pen in the housing only when the contact area of the stylus pen is aligned with the connector component.

8. The system of claim 7, wherein the moving mechanism comprises at least one magnet capable of being attracted to a magnet in the stylus pen.

9. The system of claim 7, wherein the moving mechanism is a mechanical mechanism capable of moving the movable connector device toward the stylus pen.

10. The system of claim 7, wherein the movable connector device is capable of charging the stylus pen.

11. The system of claim 7, wherein the movable connector device makes no contact with the stylus pen until the contact area of the stylus pen is aligned with the movable connector device.

12. A computing device, comprising:
a processor, and
a housing comprising:
at least one wall capable of surrounding the stylus pen; and
a movable connector device affixed to an inner portion of the at least one wall, the movable connector device comprising:
a connector component protruding into the housing and capable of connecting to a contact area of the stylus pen; and
a moving mechanism capable of moving the movable connector device toward the stylus pen in the housing only when the contact area of the stylus pen is aligned with the connector component.

13. The computing device of claim 12, wherein the moving mechanism comprises at least one magnet capable of being attracted to a magnet in the stylus pen.

14. The computing device of claim 12, wherein the moving mechanism is a mechanical mechanism capable of moving the movable connector device toward the stylus pen.

15. The computing device of claim 12, wherein the movable connector device is capable of charging the stylus pen.
